(19) United States
(12) Patent Application Publication
(10) Pub. No.: US 2013/0185038 A1
(43) Pub. Date: Jul. 18, 2013

(54) Performance Calculation, Admission Control, and Supervisory Control for a Load Dependent Data Processing System

(71) Applicants: Gabriela Radu, Lund (SE); Bertil Aspernäs, Bergkvara (SE); Andreas Torstensson, Karlskrona (SE)

(72) Inventors: Gabriela Radu, Lund (SE); Bertil Aspernäs, Bergkvara (SE); Andreas Torstensson, Karlskrona (SE)

(73) Assignee: TELEFONAKTIEBOLAGET L M ERICSSON (PUBL), Stockholm (SE)

(21) Appl. No.: 13/825,473

(22) PCT Filed: Oct. 5, 2010
(86) PCT No.: PCT/EP10/64805

§ 371 Date: Mar. 21, 2013

Related U.S. Application Data
(60) Provisional application No. 61/386,702, filed on Sep. 27, 2010.

(51) Int. Cl. G06F 11/34

(52) U.S. Cl. CPC G06F 11/3419
USPC 703/2

(57) ABSTRACT

An performance calculation apparatus, an admission rate controller, and a supervisory control and decision apparatus, and methods thereof are provided to improve the control of an admission rate of discrete service events to a data processing system. The performance calculation apparatus, the admission rate controller, and the supervisory control and decision apparatus rely on an improved mathematical modelling mechanism that determines a relation between response times of the discrete service events and their arrival rate and thus provide an improved control over the data processing system by externally monitoring the response times of the data processing system.

### TECHNICAL FIELD

The present invention relates to performance calculation, admission control, and supervisory control for a load dependent data processing system. More particularly, the present invention relates to a technology of providing a load dependent mathematical model suitable for performance calculation, adaptive control, and supervisory control for a data processing system.

### BACKGROUND

The present invention relates to a data processing system, which may be understood here as a system including at least one node executing any type of load, and thus includes any type of telecommunication and data processing system. The present invention also relates to communications within a single node or within a distributed system.

Communication systems are one type of such data processing systems which are complex and due to the load dependence may easily become unstable. In typical situations one has no knowledge about the arrival rate and no access to any inside information of the data processing system such as queue length, service rate, number of jobs in progress and the like. In particular, the load dependence of data processing system, which describes a relationship between the number of service request in progress and each request's service time, is a critical performance parameter.

Operators of such data processing systems have been very focused on growth, but the market is now stabilizing and getting much more mature. As a result the operators change their focus from growth to minimizing their operating costs (OPEX). An important way to become more cost efficient is to have a good planning of the capacity in the communication network and to make sure that the existing data processing systems are as much utilized as possible without risking overload scenarios.

Load dependent discrete event data processing systems are very common. They can best be described as systems that process some kind of jobs, for example services, and get more and more overloaded the more jobs they have to process at the same time. Even though the basic behavior of such a data processing system is easy to understand it has turned out that they are very hard to control and supervise without a detailed knowledge about their internal load dependent state.

The main reason for this is that they are very sensitive for high loads. It only requires a small number of additional service requests for the data processing system to suddenly flip from a state where it is capable of processing all the incoming discrete service events, to a state where the system completely collapse under the high load and crashes completely due to lack of resources.

Existing solutions for control and decisions of a discrete event process in a data processing system very often rely on an M/M/n model where M/M/n is the Kendalls notation of a Markov-Markov process with <n> servers queuing model. This approach is to a great extent a simplification, and it is not possible to map the load dependency behavior of data processing systems to that model.

Queuing models are often used to describe processes that can handle many tasks in parallel. A main problem is that the M/M/n queue model does not have any load dependency functionality built in. This means that the M/M/n model does not fit very well when applied to a system where internal jobs compete for common shared resources, like for example disk I/O. This is however a very common case for a lot of man-made systems, which means that the M/M/n model does not really fit many of the systems we see today.

Solely relying on the M/M/n-queue theory will therefore lead to bad controller actions and decisions for the process. The problem originates in the lack of an analytical mathematical model that can be seen as an abstract mathematical description of the performance measures for a General Purpose Load Dependent Discrete Event Process in a data processing system.

The existing solutions therefore do not only lack a way to describe the model of a load dependent system. They also lack a proper way of controlling this kind of data processing systems. The main reason for this is that these data processing systems are very sensitive for high loads and very quickly flips to a state where they suddenly crash when the load increases.

The most common way to avoid this scenario is by adding a lot of safety margins to the dimensioning of the systems, which increases the costs.

Existing solutions for regulation are based on detailed information of the internal states of the event process. For example one has to know how many pending events are currently processed. Since there are many incoming ports for the events entities, control is only possible over the one, which may be affected. This, however, is very often not known because one cannot observe the inner parts of the event process such as how many jobs there are in the server.

Further, operators of data processing systems want to run a slim operation and avoid investing a lot of money in over-capacity in the network that is never used. At the same time the service usage quickly changes when new hot services are introduced. A popular application on the AppStore could for example quickly change the service usage in the network. This means that the operator constantly need to monitor the different systems to make sure that the network provides the necessary capacity.

Today operators may also use their Operations Support Systems (OSS) to get information about the current state of their network. The problem is that OSS usually only gets information with poor value, but in large quantities.

One further problem is that the OSS gets information like CPU usage and memory usage, but this kind of information does not necessarily give a proper indication of a potential overload situation. A network element can run on 20% CPU usage, but still being overloaded due to heavy I/O operations.

Another problem is that when the OSS receives alarms and warnings about the overload of the network element, the overload is already a reality. Given lead time for a capacity upgrade in the network, the operator might face a period with overloaded systems and malfunctioning services before the capacity finally can be upgraded.

To compensate for all those problems the operators needs to add a lot of safety margins to all dimensioning, which leads to increased costs.

### SUMMARY

Based on the above problems it is a general object of the present invention to provide means for an improved control of a load dependent data processing system and to provide methods and arrangements for a performance calculation, admission control, and supervisory control for a load dependent data processing system. These and other objects are achieved in accordance with the attached set of claims.

According to one aspect the present invention provides a performance calculation apparatus for calculating at least one performance measure of a data processing system, comprising: an interface unit adapted to receive discrete service response times measured for the data processing system; a data processing system modelling unit adapted to model the data processing system using a mathematical model establishing a relationship between discrete service event response times and arrival rates of discrete service events of the data processing system; and performance measure calculation unit adapted to calculate at least one data processing, system performance measure using the mathematical model and the discrete service response times.

According to this performance calculation apparatus the determination of one or more performance measures of the load dependent data processing system may be achieved by using a mathematical model that only requires externally monitored response times as an input. Thus, no internal information of the data processing system or analysis of the type of service is required to determine the load dependent state of the data processing system. Based on the determined performance measures the load dependent systems may by advantageously controlled and supervised, such that safety margins for the dimensioning of the system and therefore the costs of such systems are greatly reduced.

According to another aspect the present invention provides an adaptive admission rate controller for adaptive admission control of discrete service events submitted to a data processing system, comprising: a controller unit adapted to execute an adaptive admission rate control for discrete service events to achieve a desired response time on the basis of monitored discrete service event response times and a admission rate control parameter (K) calculated from a mathematical model establishing a relationship between discrete service event response times and arrival rates of discrete service events.

According to another aspect the present invention provides a method of adaptive admission rate control for a discrete service event in a data processing system, comprising the steps of: monitoring discrete service event response times for at least one predetermined period of time; executing an adaptive admission rate control for discrete service events to achieve a desired response time on the basis of the monitored discrete service event response times and a admission rate control parameter (K) calculated from a mathematical model establishing a relationship between discrete service event response times and arrival rates of discrete service events.

According to this adaptive admission rate controller and this method of adaptive admission rate control the admission rate for the data processing system is controlled based only on externally monitored response times of the data processing system and relying on the mathematical model. Therefore, the admission rate can be adaptively controlled in real time, fluctuations of the incoming data traffic can be effectively handled, and running into an overload state can effectively and efficiently be prevented. Therefore safety margins for the dimensioning of the data processing system and therefore the costs of such systems are greatly reduced.

According to another aspect the present invention provides a supervisory control and decision apparatus for a data processing system, comprising: a monitoring unit adapted to monitor discrete service response times for at least one predetermined period of time; a performance measure determining unit adapted to determine at least one load dependent performance measure of the data processing system on the basis of the monitored discrete service response times and a mathematical model establishing a relationship between discrete service event response times and arrival rates of discrete service events; and control strategy deciding unit adapted to decide on a control strategy according to the at least one load dependent performance measure on the basis of a degree of utilization and/or a set of pre-established regulation rules for the data processing system.

According to another aspect the present invention provides a method of supervisory and decision control of a data processing system, comprising the steps of: monitoring discrete service response times for at least one predetermined period of time in the data processing system; determining at least one load dependent performance measure of the data processing system on the basis of the monitored discrete service response times and a mathematical model establishing a relationship between discrete service event response times and arrival rates of discrete service events; and deciding on a control strategy according to the at least one load dependent performance measure on the basis of a degree of utilization and/or a set of pre-established regulation rules for the data processing system.

According to this supervisory control and decision apparatus and this method of supervisory and decision control the data processing system can be effectively and efficiently monitored and supervised, such that the configuration of the data processing system may be changed in a way that the load dependence characterized in the mathematical model is reduced and an overload of the system is avoided.

### BRIEF DESCRIPTION OF THE FIGURES

FIG. 1 is a diagram showing a curve based on a relationship between response times of discrete service events as a function of an arrival rate and a comparison between measurement data and simulation results based on a mathematical model.

FIG. 2 shows a state transition rate diagram of the mathematical model used for the present invention.

FIG. 3 shows a performance calculation apparatus according to the present invention.

FIG. 4 shows an inverse of the curve gradient of the mathematical model curve used for determining an admission rate control parameter K.

FIG. 5 shows a reading apparatus for externally monitoring the response times of discrete service events in the data processing system.

FIG. 6 shows an adaptive admission rate controller for adaptive admission rate control of discrete service events that are submitted to a data processing system according to the present invention.

FIG. 7 further shows another example of the adaptive admission rate controller according to the present invention.

FIG. 8 shows PI-controller used in the adaptive admission rate controller according to the present invention.

FIG. 9 shows another example of the admission rate controller according to the present invention.

FIG. 10 shows flow chart describing a method of adaptive admission rate control for a discrete service event in a data processing system according of the present invention.

FIG. 11 shows a flow chart describing a preferred embodiment of the method of adaptive admission rate control for a discrete service event in a data processing system according of the present invention.

FIG. 12 shows a supervisory control and decision apparatus for a data processing system according to the present invention.

FIG. 13 shows a method for deciding a control strategy used for a data processing system according to the present invention.

FIG. 14 shows an example of a supervisory view according to the present invention.

FIG. 15 shows another example of a supervisory view according to the present invention.

FIG. 16 shows a flow chart describing a supervisory and decision control method according to the present invention.

FIG. 17 shows a flow chart describing another example of the supervisory and decision control method according to the present invention.

FIG. 18 shows a flow chart describing another example of the supervisory and decision control method according to the present invention.

FIG. 19 shows an adaptive admission rate control system according to the present invention.

FIG. 20 shows another example of an adaptive admission rate control system according to the present invention.

FIG. 21 shows an implementation of an admission control solution according to the present invention.

FIG. 22 shows an implementation of a supervisory control and process optimization solution according to the present invention.

FIG. 23 shows an implementation of a supervisory control and benchmarking solution according to the present invention.

FIG. 24 shows an implementation of a capacity planning solution according to the present invention.

### DETAILED DESCRIPTION

According to the present invention, there is provided a performance determination, an adaptive admission rate control, and a supervisory and decision control, which relies on an improved mathematical modelling mechanism, which is used to predict, determine, control, and supervise an admission rate for discrete service events to the data processing-system. In particular, the mathematical model will be used to predict, determine, control, and supervise the admission rate of discrete service events.

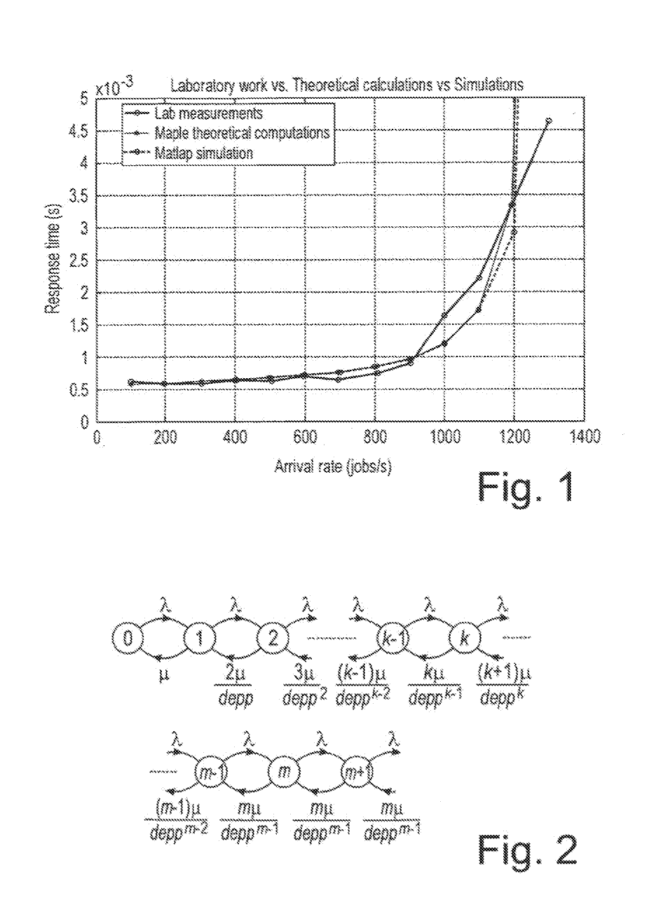

FIG. 1 shows that a rate of discrete service events, shown on the abscissa of FIG. 1, for example jobs entering a data processing system, influences the response time of the discrete service event, shown on the ordinate of FIG. 1, which is the time between entering and leaving the data processing system. In case of higher loads of the data processing system this response time increases

FIG. 1 shows a measured dependence of the discrete service event response time and a simulated dependence of the discrete service event response time based on the mathematical model used for the present invention. Such discrete service event response times as a function of the arrival rates of discrete service events may be measured inside a data processing system or simulated with detailed information about internal states of the data processing system.

According to FIG. 1, the measured response times strongly depends on the arrival rate such that for increasing arrival rates the response times increase almost exponentially. In FIG. 1, for example, above an arrival rate of about 1000 jobs per second, the increase in the response time is so strong that the system quickly runs into an overload state. As explained above, such a system response could not be described well with a mathematical model of the prior art.

FIG. 2 shows a state transition rate diagram of the mathematical model used for the present invention. According to FIG. 2, the load dependent state of the data processing system is modelled as a birth-death chain with a birth parameter λₖ and a load-dependent death parameter μₖ, wherein 0, 1, . . . , k−1, k, . . . , m+1 denotes the number of discrete service events in the data processing system. According to FIG. 2, adding a discrete service event is described by the same birth parameter λ=λₖ, whereas deleting a discrete service event is described by a load dependent parameter μₖ, which depends on a load parameter depp of the data processing system.

The new mathematical model according to FIG. 2 is thus based on two hypothesis. In particular, since many service requests are processed in parallel in the data processing system there normally are resource collisions in the system due to the fact that number of resources is a limited number. Resource collisions make requests have to wait for CPU, memory or disc access before they can be executed. For example disc access can be unavailable due to mutex-lock from other service requests (or internal jobs) which limits the time window for allow writing to disc. Collision makes therefore the overall process slow down.

According to FIG. 2 the main hypothesis is that resource collisions in communication server systems cause the occurrence of waiting times for discrete service events, such as services or jobs. For example, collisions between jobs occur when jobs simultaneously run for the same resource at the same time instant and some jobs must therefore wait. The more collisions there are in the data processing system the more waiting time is building up. The result is a decrease in performance of the data processing system. In particular, it is likely that there are more resource collisions under a high load state, that is for a higher value of depp, for example for many parallel jobs in the data processing system.

According to FIG. 2 and the new mathematical model, the second hypothesis further relates to how waiting times build up. For every additional job that is entering the process an extra service time is being added because of a load dependency of the data processing system. Waiting time is added to the remaining service time for all jobs in progress. For a load dependency of, e.g., depp=1.16 the added time is 16% of remaining service time. If two jobs are entering the new service time, this is 1.16*1.16 of the original service response time, which means that the load dependency is a progressive function of number of jobs in server.

The load dependency may be caused by resource collision. Resources in a data processing system, for example a server system, are for example CPU, memory, disc access, etc. The implementation of a server system challenges the designer to use available resources in run time as good as possible. Server system can be broken down to many small service requests which for their execution occupy resources such as CPU, memory and disc access.

According to FIG. 2, the new mathematical model is thus an M/M/m-LDx queuing system with unlimited queue. It models the data processing system as a birth-death chain with a birth parameter λₖ and a death parameter μₖ

$${λ}_{k} = λ for all k = 0 , 1 , … \\ {μ}_{k} = \{ \begin{matrix}\frac{k \cdot μ}{{depp}^{k - 1}} & if 0 \leq k < m \\ \frac{m \cdot μ}{{depp}^{m - 1}} & if k \geq m\end{matrix} \qquad ( 1 )$$

wherein k is the number of discrete service events, m is the number of servers in the data processing system, and depp is a parameter related to the load dependence of the data processing system. In particular, the value of parameter depp is related to the steepness of the curve shown in FIG. 1 and thus described the load dependency of the waiting times in the data processing system.

The mathematical model shown in FIG. 2 assumes that each new incoming job causes a percentage increase in remaining service time duration on all jobs in progress. At service completion, likewise, the job leaving the system will unstress the system resulting in a percentage decrease in remaining service time on all jobs in progress.

Further, the load dependent parameter depp in FIG. 2 is a measure for how big impacts the resource collisions have on the performance measures and thus is related to the percentage change in service time duration due to change in the number of service request in progress. A data processing system, such as a communication unit, with a high value of depp indicates that the software implementation is bad causing unnecessary many resource collisions.

As further shown in FIG. 1, the mathematical model of the present invention provides an agreement of the relationship between discrete event response times and the arrival rates of discrete service events that is actually measured for a data processing system.

The above hypothesises resulting into the new mathematical model have thus been validated against server lab experimental data, simulations and analytical calculations, see FIG. 1. In particular the mathematical model may be represented as a model curve describing the service event response times as a function of incoming service request rates. It is observed from FIG. 1 that all results show that the hypothesis based on the new mathematical model is a very good match.

Setting parameter depp to 1 the model reverts back to a traditional. MMn queuing model that is well documented throughout the literature. Doing that the mathematical model, however, cannot describe the measured load dependency behavior.

The load dependent mathematical model permits derivation and calculation of several performance measures of the data processing system to be used for performance calculations according to the present invention, which are described below. It further provides access to inside information of the data processing system by externally monitoring service response times. It further allows for both the designing of high performance queueing systems and for analyzing, supervising and improving existent systems.

### Embodiment 1

### Performance Calculation Apparatus

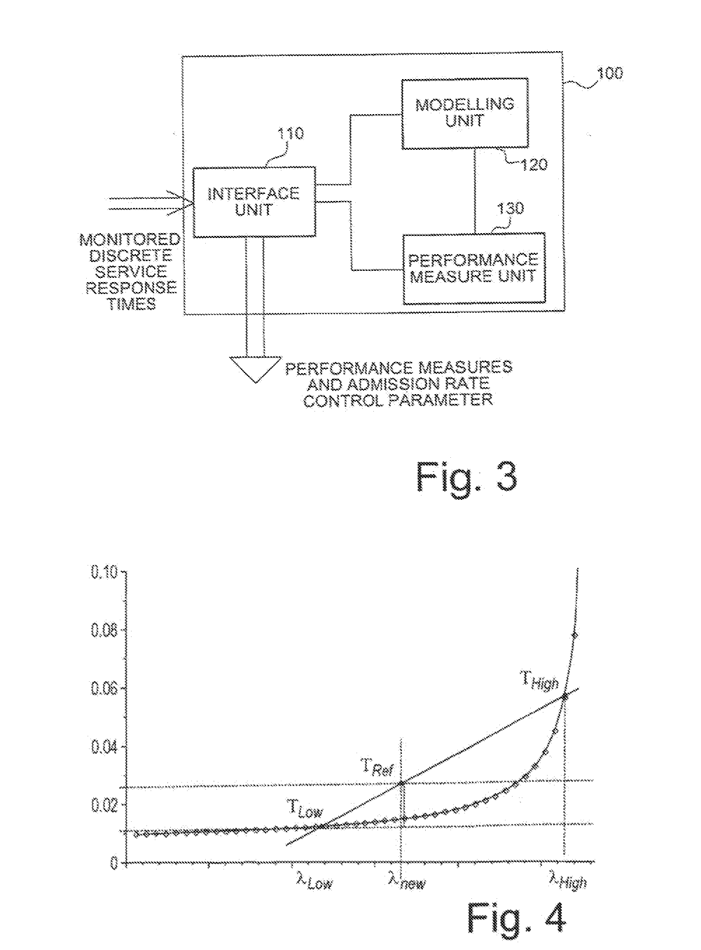

In the following an embodiment of the present invention being related to a performance calculating apparatus will be described with respect to FIG. 3.

FIG. 3 shows a performance calculation apparatus 100 for calculating at least one performance measure of a data processing-system according to the present invention.

The performance calculation apparatus 100 shown in FIG. 3 comprises an interface unit 110, a data processing system modelling unit 120, and a performance measure calculation unit 130.

The interface unit 110 shown in FIG. 3 receives monitored discrete service response times, which are remotely measured for the data processing system.

The data processing system modelling unit 120 shown in FIG. 3 mathematically models the data processing system using the above mathematical model and therefore a relationship is established between discrete service event response times and arrival rates of discrete service events of the data processing system, as shown in FIG. 1.

The above analytical mathematical model according to FIG. 2 may further be used in the performance calculation apparatus 100 shown in FIG. 3 to determine performance measures for a General Purpose Load Dependent Discrete Event Process.

In the following three examples of such performance measures are provided:

First, a current stress level may be related to counting the number of discrete service events, for example jobs, entering and leaving the data processing system. This current stress level reflects the observation that each new incoming job causes a percentage increase in remaining service time duration on all jobs in progress. At service completion, the job leaving the system will be unstressing the data processing system resulting in a percentage decrease in remaining service time duration on all jobs in progress.

Second, a calculation of stationary probability distribution for the number of discrete serviceevents, for example jobs, in the data processing system, which results analytically from the above load dependent mathematical model and may be performed according to the equation

$${π}_{k} = \{ \begin{matrix}{( \frac{λ}{μ} )}^{k} \frac{1}{k !} {depp}^{\frac{k ( k - 1 )}{2}} {π}_{0} , & k < m \\ {( \frac{λ}{μ} )}^{k} {( \frac{1}{m} )}^{k - m} \frac{1}{m !} {depp}^{( m - 1 ) ( k - \frac{m}{2} )} {π}_{0} , & k \geq m\end{matrix} \\ {π}_{0} = \frac{1}{\begin{matrix}1 + {\sum }_{k = 1}^{m - 1} {( \frac{λ}{μ} )}^{k} \cdot \frac{1}{k !} \cdot {depp}^{\frac{k \cdot ( k - 1 )}{2}} + \\ {( \frac{λ}{μ} )}^{m} \frac{1}{m !} {depp}^{\frac{m ( m - 1 )}{2}} \cdot \frac{μ m}{μ m - λ {depp}^{m - 1}}\end{matrix}}$$

wherein λ represents the average arrival rate, μ represents the average service rate, m represents the number of servers in the data processing system, k is the number of discrete service events, and depp is the load dependency parameter.

And third, a calculation of average response times for the number of discrete service events, for example jobs, in the data processing system also results analytically from the above load dependent mathematical model and may be performed according to the following equation

$$T := π 0 \cdot ( \begin{matrix}\frac{1}{μ} {\sum }_{k = 1}^{m - 1} \frac{{( \frac{λ}{μ} )}^{k - 1} {depp}^{\frac{1}{2} k ( k - 1 )}}{( k - 1 ) !} + \\ \frac{{( \frac{λ}{μ} )}^{m - 1} m {depp}^{\frac{1}{2} ( m - 1 ) m} \cdot ( - λ ( m - 1 ) {depp}^{m - 1} + μ {m}^{2} )}{m ! {( - λ {depp}^{m - 1} + μ m )}^{2}}\end{matrix} )$$

wherein λ represents the average arrival rate, μ represents the average service rate, m represents the number of servers in the data processing system, k is the number of discrete service events, and depp is the load dependency parameter, as above.

The performance measure calculation unit 130 shown in FIG. 3 determines at least one of the above data processing system performance measures using the mathematical model and the monitored discrete service response times. The performance calculation apparatus 130 thus also implements a method for calculating the current stress level, and methods for calculating the stationary probability distribution for the number of jobs in data processing system and their average response times.

The performance measure calculation unit 130 shown in FIG. 3 may also derive an inverse of the curve gradient, that is an inverse of the slope of the model curve at a reference response time T_ref, shown in FIG. 4, as a load dependency parameter h for subsequent use in an adaptive admission rate control process of the data processing system to be described below.

With the implementation of the above mathematical model into the performance calculator apparatus 100 shown in FIG. 3 it is thus possible to calculate the performance measures by only knowing what events are entering the process and their response times.

The performance calculation apparatus 100 shown in FIG. 3 may support other system components, such as an adaptive admission rate controller and a supervisory control and decision control apparatuses.

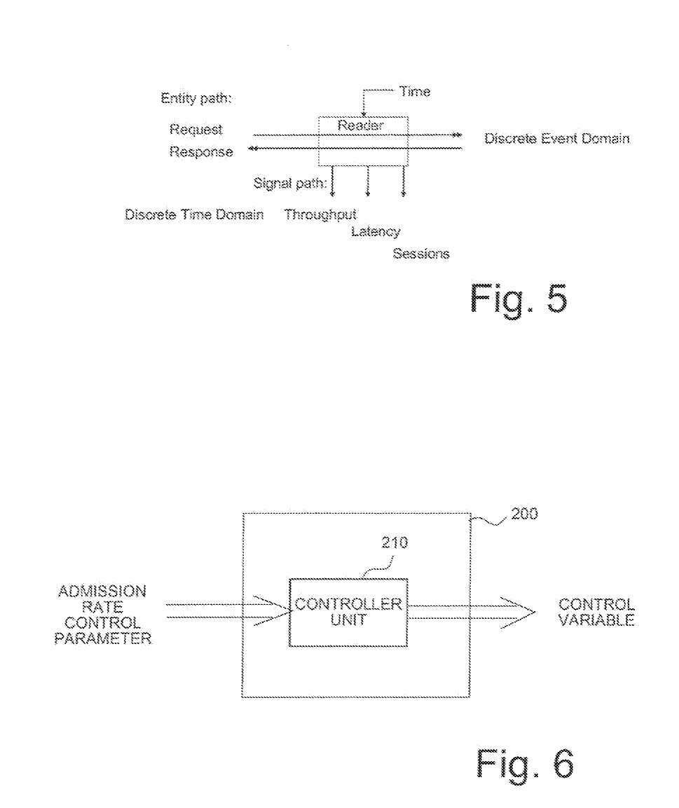

According to FIG. 5, a reading apparatus may be used to monitor the discrete service response times used in the performance calculating apparatus 100 shown in FIG. 3. The reading apparatus shown in FIG. 5 is triggered by a request or a response entering or leaving a network element of the data processing system in a discrete event domain. The reading apparatus sniffs on requests and responses passively on the traffic flow to and/or from the data processing system. Passively means here it may read time stamps, type and identity of the requests/response passing the reading apparatus without any other extraction of information. According to FIG. 5, the reading apparatus may calculate and temporarily store for each request/response the triplet latency, throughput and number of sessions.

In other words the reading apparatus shown in FIG. 5 transforms entities from the Discrete Event Domain to Discrete Time Domain. It uses time information to carry out the work. The reader apparatus further implements a method to transform from a Discrete Event Domain to a Discrete Time Domain.

### Embodiment 2

### Adaptive Admission Rate Controller

In the following an embodiment of the present invention being related to an adaptive admission rate controller will be described with respect to FIG. 6.

FIG. 6 shows an adaptive admission rate controller 200 for adaptive admission rate control of discrete service events that are submitted to a data processing system according to the present invention.

According to FIG. 6 the adaptive admission rate controller 200 comprises a controlling unit 210 and receives an admission rate control parameter K and outputs a control variable.

The adaptive admission rate controller 200 shown in FIG. 6 comprises a controller unit 210 that is adapted to execute an adaptive admission rate control for discrete service events in order to achieve, e.g., a desired response time T_ref on the basis of the monitored discrete response times and the admission rate control parameter K, which is calculated from the above mathematical model establishing a relationship between discrete service response times and arrival rates of discrete service events, as described above. According to FIG. 4, a second method, which is described below, seeks a curve slope value at T_ref. The admission rate control parameter K is determined by the inverse of the curve slope. High load values of the data processing system will give rise to low K values, that is a high steep slope, whereas low load values of the data processing system will give rise to high K values; that is a slow steep slope.

The admission rate control parameter K may thus be based on particular features of the relationship between discrete service response times and arrival rates of discrete service events, which is appropriate for controlling arrival rates. As shown above in relation to FIG. 4 and further described below, an inverse of the curve gradient of the model curve may be used as the admission rate control parameter K.

Based on the admission rate control parameter K, the adaptive admission rate controller 200 shown in FIG. 6 outputs a control variable to adaptively control a general purpose discrete event process.

Control variables outputted from the adaptive admission rate controller 200 shown in FIG. 6 are chosen such that the states of the process are controllable, for example to control the average response times in the network element of the data processing system. Typically the control variable can be a gate that closes or opens in the request flow of service requests or an imposed extra latency in flow to prevent new request coming in to the Network Element and the like.

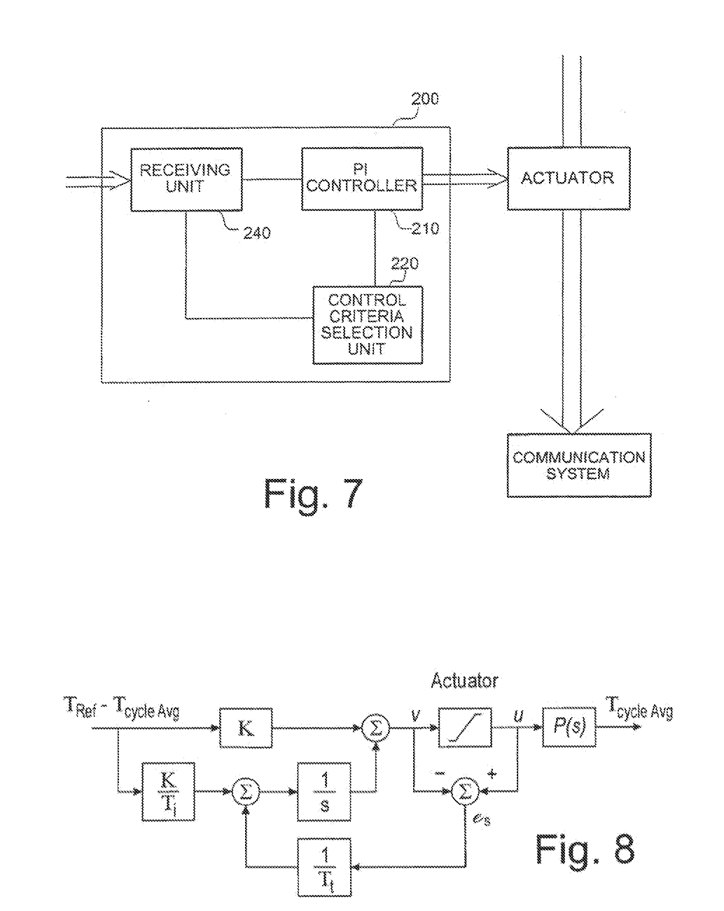

FIG. 7 further shows an example of the adaptive admission rate controller 200 according to the present invention, which further comprises a receiving unit 240 and a control criteria selection unit 240 and a control criteria selection unit 220. In the example of FIG. 7 the controlling unit 210 is implemented as a PI-controller. As shown in FIG. 7 the adaptive admission rate controlling process for the discrete service events in the data processing system may then implemented through an actuator. The control criteria for the control criteria selection unit 220 in FIG. 7 specify what the controller 200 wants to achieve. For example the controller 200 can try to hold response times to not go above a certain value, for example the time reference (T_ref). Other criteria can be keep the server utilization high as possible or maintain a high sustainable throughput.

According to FIG. 7 the receiving unit 240 is adapted to receive the admission rate control parameter K from the external performance calculation apparatus described above. In particular, the admission rate control parameter K is calculated and updated in real time. The receiving unit 240 shown in FIG. 7 may also be adapted to receive the above described performance measures.

According to FIG. 7 the control criteria selection unit 220 may be arranged to select a control criteria underlying the performance maximization of the data processing system. Such a control criteria may for example be related to a criteria such that the discrete service response time is not above T_ref, to keep a data processing system server utilization as high as possible and/or to maintain a high sustainable throughput.

Further, the PI-controller 210 shown in FIG. 7 is being operated according to the calculated admission rate control parameter K. The PT-controller 210 comprises a non-linear load adaptive unit, which is adapted to block a wind up of the PI control process.

A specific example of such a PI-controller 210 in the adaptive admission rate controller 200 according to the present invention is shown in FIG. 8. The PI-regulation according the PI-controller shown in FIG. 8 takes the output from the control criteria, for example a difference between reference time (T_ref) and a current response time (T_cycleAvg) and multiplies this with the above described admission rate control parameter K from the Load Calculator (which implements the Iterative Secant Calculation Method) and set the control variable, the admitted rate for the process we are trying to control. Further, in the PI-controller 210 according to FIG. 8 the parameter u is the control variable and P(s) is the process to be controlled. K is the load adaptive gain from the load calculator and T_cycleAvg is the measured averaged response time from the process and T_ref comes from the controller criteria. This forms a direct path in the regulation of the PT-controller. An integral path in the PI-controller 210 is accumulating long term difference and adds to the direct path in summation point. The integral path holds an integral gain T_i that is set for compensating for off-set errors. Further, the anti-windup path inhibits the integral path to over-compensate at large changes in load. Path holds a gain K_t that decides the setting time. The PI-controller 210 is thus a PI-controller with anti-windup. The PI-controller 210 is further modified with a load adaptive non-linear part. The controller gain is related to the admission rate control parameter K described above and is calculated with the above non-linear iterative secant method. The controller gain is inserted into the PI-controller apparatus in run time which makes the controller load-adaptive. The integral action in the PI-controller takes care of possible steady state errors in the control criteria. The anti-windup takes care of stability problems at large disturbances in workload.

The PI-controller 210 according to FIG. 8 may further form a control strategy to set the control variable to regulate according to a control criteria. The controller is designed to have the ability to weight the controlling effort against how fast controlling action should affect the process.

The PI-Controller 210 according to FIG. 8 may be further designed to operate at a certain rate. Normally the reading apparatus, the controller, the actuator and a Supervisory Control & Decision Rule Engine described below operate at the same sample rate but deviations are possible for having different bandwidths requirements. An output from the PI-Controller 210 according to FIG. 8 is sent to the Actuator apparatus for execution and to a Reporter described below for information.

Control variables to be output from the admission rate controller 200 shown in FIGS. 6 and 7 are chosen such that the states of the process are controllable. Typically the control variable may be a gate that closes or opens in the request flow of service requests, for example in the actuator, or an imposed extra latency in flow to prevent new requests coming in to the Network Element of the data processing system.

According to FIG. 7, the adaptive admission of discrete service events to the data processing system is then implemented through an actuator, and the controller unit 210 shown in FIGS. 6 and 7 may, as described above, control the adaptive admission rate control by modifying a gate opening or closing in the actuator and/or by imposing latency in flow in the actuator.

According to FIG. 7 the actuator is the executor of the controlling variable. This means that the output from the PI-Controller 210 is the input to the Actuator. Two alternative control variables were described above, but there can be others. First, for the case of control variable being the request rate the actuator is performing the opening and closing functionality of a gate. Second, for the case of control variable being the request rate the actuator impose more or less latency in the response flow from Network Element. In both cases the actuator shown in FIG. 7 is controlling the flow through the system.

The actuator shown in FIG. 7 may further execute at a constant rate and the opening and closing function may coincide with discrete event time when request are entering or leaving the system.

The present invention thus includes a new type of adaptive admission rate control apparatus that can regulate the incoming load to the current capacity of a load dependent data processing system. Using the above new mathematical model the adaptive admission control performed by the controller apparatus 200 may be unexpectedly only rely on an external observation of a current state of the data processing system may automatically regulate the traffic to prevent overload scenarios. This will make it possible to dimension networks and data processing systems with a much higher utilization.

In an alternative embodiment of the admission rate controller of present invention, the controller apparatus may take the estimated states from a Supervisory Control described below and forms a control strategy to set the control variable to regulate according to a control criteria. The controller apparatus is designed to have the ability to weight the controlling effort against how fast controlling action should affect a Network Element in the data processing system. In a further alternative embodiment of the of the admission rate controller of present invention, shown in FIG. 9, the above performance calculating apparatus 100 determining the above performance measures and in addition also the admission rate control parameter based on the mathematical model may be implemented directly into adaptive admission rate controller 200. The load calculator is observing the latency curve, shown in FIG. 1, which is formed when the event system is working. It finds the inverse of the curve gradient shown in FIG. 4 of response time versus incoming request rate. This gradient changes with the current load of the event process we are trying to control. This curve gradient (slope of the curve) is used to calculate the proportional gain K as l/slope, which is then inserted into the load adaptive PI-controller with anti-windup shown in FIG. 8.

Controlling a general purpose discrete event process is a hard thing to do. The present invention demonstrates that it is achievable if the load dependency of the data processing system, e.g. that of a server, is a concave monotonous a function of incoming event rate. However the concavity and monotonity requirement is not a limitation. Most man-made systems show performance degradation progressively when the work burden is starting to get overwhelming. In same way it is not a limitation to assume the monotonitiy either.

If any of the limitations above are excluded we are dealing with a chaotic or pure random system or a fractal behavior, typical as the case we see in weather systems. Most man-made systems are however possible to analyse, adaptively control, and supervise with the present invention. This means that the present invention is generally applicable to any type of data processing system.

The present invention thus relies purely on what can be observed from the outside of the process. This means that by measuring the response tunes from e.g. a server in the data processing system, we can indirectly have knowledge about how high the load is, that is how many events are currently under processing. The present invention thus solely depends of indirect sensing the server work load by measuring the response times. This means that is possible to implement the present invention without modifying existing protocols and other information carriers, which makes the invention even more general.

### Embodiment 3

### Adaptive Admission Control Method

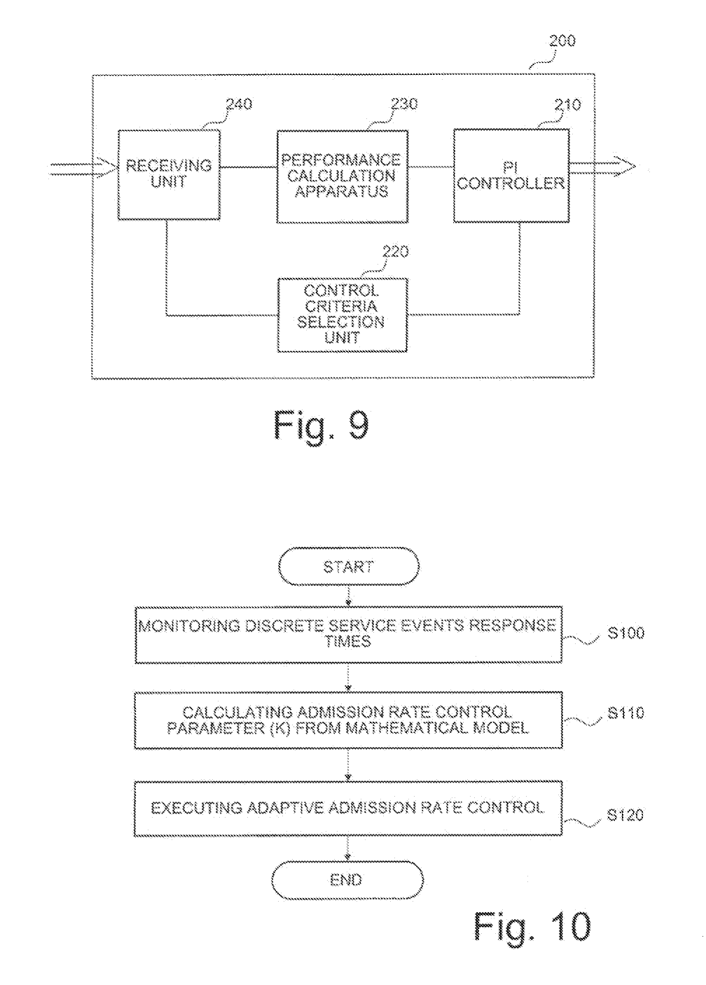

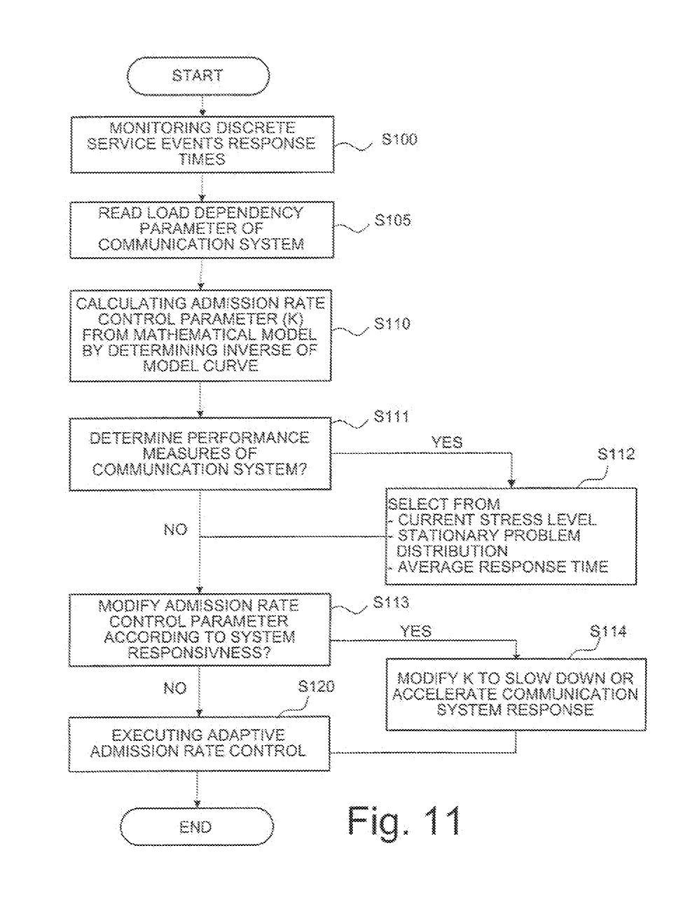

In the following an embodiment of the present invention being related to an adaptive admission control method will be described with respect to FIG. 10.

FIG. 10 shows flow chart describing a method of adaptive admission rate control for a discrete service event in a data processing system according of the present invention.

In a first step S100, according to FIG. 10, discrete service response times are monitored for at least one predetermined period of time.

In a further step S120 adaptive admission rate control for discrete service events is executed to achieve a desired response time. This adaptive admission rate control is achieved on the basis of the monitored discrete service event response times and the admission rate control parameter K, described above. This admission rate control parameter K is calculated in a step S110 from the mathematical model that established a relationship between discrete service event response times and arrival rates of discrete service events.

The mathematical model may further be used to derive the above control parameter K from the inverse of the curve slope of the model curve. The above control parameter K may be found, for example, from an iterative secant calculation according to FIG. 4. This method implements a search algorithm that by successive secant calculations finds the inverse of the slope of the latency curve shown in FIG. 4 at current load described by parameter depp.

In particular, the iterative secant calculating keeps track of λ_Low, T_Low, λ_High, T_High at all times (all λ=% of total incoming rate) and uses the following iteration formula:

According to FIG. 4, the interval [λ_Low, λ_High] contains the true arrival rate λRef that generates a response time equal to TRef. This interval decreases in each iteration step, λRef being tightened between these two points. The secant line that can be observed in FIG. 4 will converge to the tangent to the curve at the point (λRef, TRef), described by the following expression

λ_new=λ_old+(λ_High−λ_Low)/(T_High−T_Low)*(T_Ref−T_cycleAvg)

In each measurement the interval (λ_Low, λ_High) is tightened. When the algorithm has converged we find λ_new, that is the value that generates a discrete service response time=TRef. The inverse of the slope of the secant is the above control parameter K or proportional gain K

K=(λ_High−λ_Low)/(T_High−T_Low)

in the regulation algorithm and is used in the adaptive PI-controller of the adaptive admission rate controller 200 shown in FIGS. 7 and 8.

In a preferred embodiment of the present invention being related to an adaptive admission control method will be described with respect to FIG. 11.

According to FIG. 11, in a further step S111 it may be identified whether performance measures of the data processing system should be determined. In the affirmative case, one or more performance measures of the data processing systems are is selected in step S112, which may be for example, a current stress level, stationary probability distribution for a number of discrete service events in the data processing system, and averaged response times for the discrete service events in the data processing system.

According to FIG. 11, in a further step S113 it may be determined, whether the above adaptive admission rate control parameter K may be modified in a step S114 according to data processing system responsiveness requirements.

In particular, increasing the proportional gain K speeds up the control action on the expense of some introduction of oscillatory behaviour. It may thus be possible to choose to replace K with Knew according to the following equation:

Knew=γ×K,

wherein γ is in a damping ratio in a range between 0.9 and 1, to achieve a damping ratio above 0.7 gives rise to a response time as fast as possible but without an oscillatory behaviour. The data processing system will then show a small overshoot, that is, when changing the reference value this is reached from below or above with only a slight crossing over the reference value.

The adaptive admission control method shown in FIG. 10 may thus be used in an independent component that can be deployed on any system. It has a model that describes the expected behavior of process. It detects when performance measures are such as there is a need for interference via a controlling action. Intervention can be of slowing down the job pace or increase the number of servers in the process or upgrade with high performance hardware.

The adaptive admission rate control method may further comprise a step for deciding on a control strategy according to the at least one load dependent performance measure. Such a control strategy may be based on a degree of utilization and/or a set of pre-established regulation rules for the data processing system, as described above.

### Embodiment 4

### Supervisory Control and Decision Apparatus

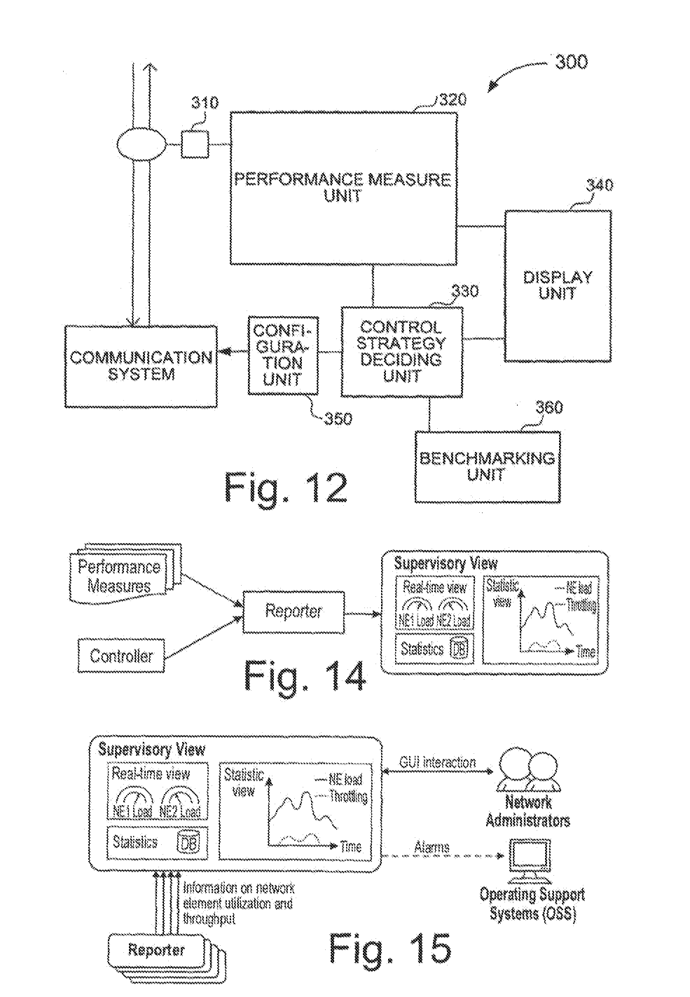

In the following an embodiment of the present invention being related to a Supervisory control and decision apparatus will be described with respect to FIG. 12.

FIG. 12 shows a supervisory control and decision apparatus 300 for a data processing system according to the present invention.

According to FIG. 12, the supervisory control and decision apparatus 300 comprises a monitoring unit 310, a performance measure unit 320, and a control strategy deciding unit 330.

The monitoring unit 310 shown in FIG. 12 monitors and determines discrete service response times of discrete service events in the data processing system for at least one predetermined period of time. An example of such a monitoring unit is also shown in FIG. 5.

The performance measure determining unit 320 shown in FIG. 12 may be arranged to determine at least one the above load dependent performance measures of the data processing system on the basis of the monitored discrete service response times and the above mathematical model for establishing a relationship between discrete service event response times and the arrival rated of discrete service events.

The performance measure determining unit 320 shown in FIG. 12 may be further arranged to determine the admission rate control parameter K for usage in the supervisory control and decision process.

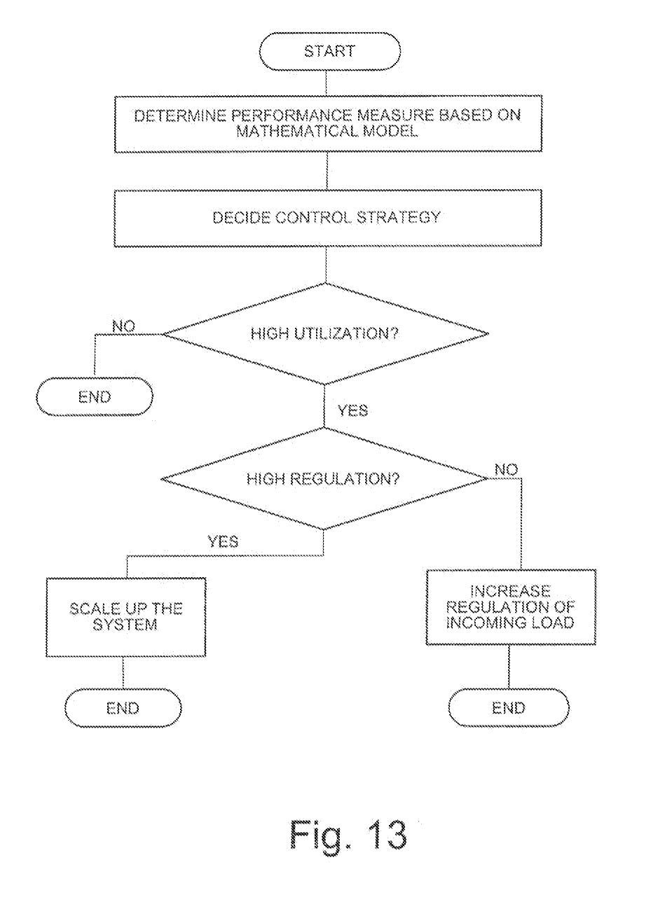

Further, the control strategy deciding unit 330 shown in FIG. 12 may decide upon a control strategy for the data processing system. According to an example shown in FIG. 13 such a control strategy may be related to at least one of the above load dependent performance measures. On the basis of a degree of utilization of the data processing system and/or a set of pre-established regulation rules, the data processing system may be either decided to be changed in scale, for example by a change in the hardware and/or software configuration, or by a change in the regulation of the incoming load into the data processing system.

In addition, according to FIG. 12, the supervisory control and decision apparatus 300 may be provided with a display unit 340 to display in real time a view of the current load dependent state of the data processing system on the basis of the above mathematical model. FIGS. 14 and 15 provide further example of such a display unit 340 as a supervisory view, which may provide for example a real time view of the load dependency of the data processing system, a statistical analysis according to a database of the load dependency and an associated statistical view. In one example embodiment of the Statistics View the y-axis represent ‘NE load’ and/or ‘Throttling’ while the x-axis represents ‘time’.

In the case that the data processing system comprises more than one network element, the display unit 340 shown in FIG. 12 may display a view of the current load dependent state of at least one of the network elements in the data processing system. An example of such a display unit is shown in FIG. 15.

Furthermore, according to FIG. 12, the supervisory control and decision apparatus 300 is provided with a data processing system configuration unit 350. The data processing system configuration unit 350 may be used to change a software configuration of the data processing system. Such a software configuration change may be performed such that the value of the load dependency parameter depp of the mathematical model is reduced.

As shown in FIG. 12, the supervisory control and detision apparatus 300 may further be provided with a benchmarking unit 360. The benchmarking unit 360 may derive a desired data processing system response behaviour for a given data processing system processing load from pre-established benchmarked performance measures.

Together with the control strategy deciding unit 330 shown in FIG. 12, which may decide on the control strategy to meet the desired data processing system response time, the benchmarking unit 360 may support such a control strategy decision based on benchmarked data stored in the benchmarking unit 360.

Intelligent and condensed information about regulation and the current state of one or more network elements in the data processing system will thus be provided as a planning tool in the supervisory control and decision apparatus. This planning tool will show a real time view of the current state of the network elements, like normal operation, under-capacity or over-capacity. It will also provide a view where it is possible to examine historic data, get statistics and do trend analysis. This will visualize the current system utilization and give an operator an early warning about necessary software and/or hardware upgrades that is before the data processing system runs into an overload state.

Further, the introduction of a rule engine in the control strategy and deciding unit 330 of the supervisory control and decision apparatus 300 shown in FIG. 12 will make it possible for the user to in a flexible way introduce new business rules for the control strategy. This will turn the component into an expert system that evolves and gets refined over time.

The possibility to benchmark the control strategy based on the benchmark unit 360 shown in FIG. 12 in the supervisory control and decision apparatus 300 with a best example process makes it possible to monitor deviations of expected performance due to redundancy, geographic location, system version and vendor and the like.

### Embodiment 5

### Supervising Load Dependent Systems

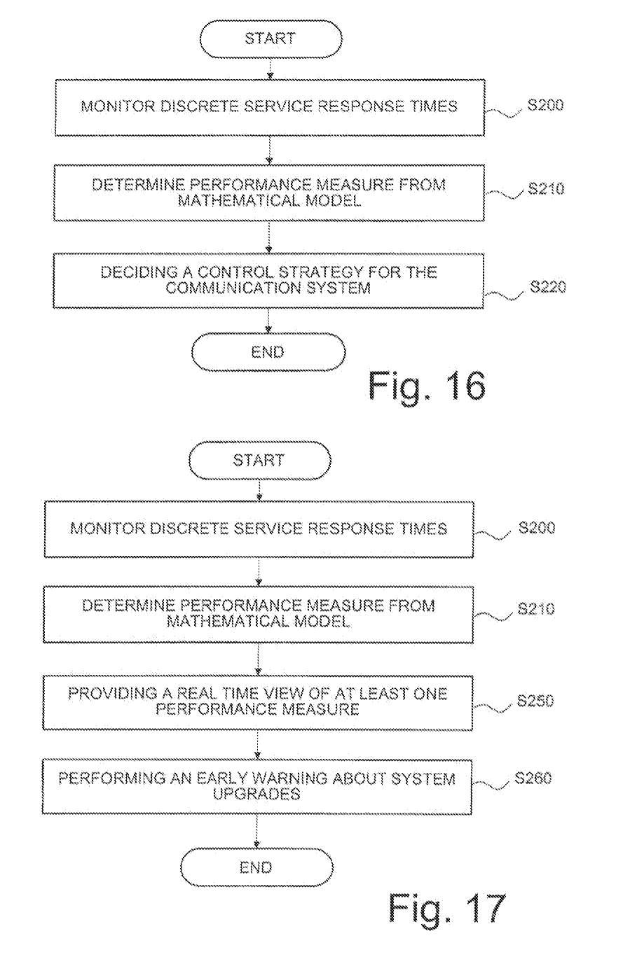

In the following an embodiment of the present invention being related to a supervisory and decision control method will be described with respect to FIG. 16.

According to FIG. 16, the method of supervisory and decision control for a data processing system includes a step S200, wherein discrete service response times are monitored for at least one predetermined period of time in the data processing system; a step S210, wherein at least one of the above load dependent performance measures of the data processing system is determined on the basis of the monitored discrete service response times and the above mathematical model that establishes a relationship between discrete event response times and arrival rates of discrete service events; and a step S220, wherein according to the at least one load dependent performance measure, a control strategy is decided based upon a degree of utilization and/or a set of pre-established regulation rules for the data processing system.

The control strategy may be either based on e.g. a human intervention into the data processing system or a change of a control software or control algorithm.

FIG. 17 shows a flow chart describing the method of supervisory and decision control for a data processing system of the present invention, which further includes a step S250, wherein a real-time view is provided of at least one the above performance measures of at least one network element in the data processing system, and a step S260, wherein an early warning is provided about system upgrades in at least one network element of the data processing system.

As also shown in FIGS. 14 and 15, such a real time view provides information for network administrators on the network element utilization and throughput, as e.g. given by the present load of the network elements of the data processing system. In case of imminent system overload, a warning alarm may be send to the operating support systems (OSS) or directly to the network administrators. The warning alarm may additionally include a message to change the data processing system implementation, for example to upgrade the system. Such system upgrades may be related to both software updates and hardware upgrades.

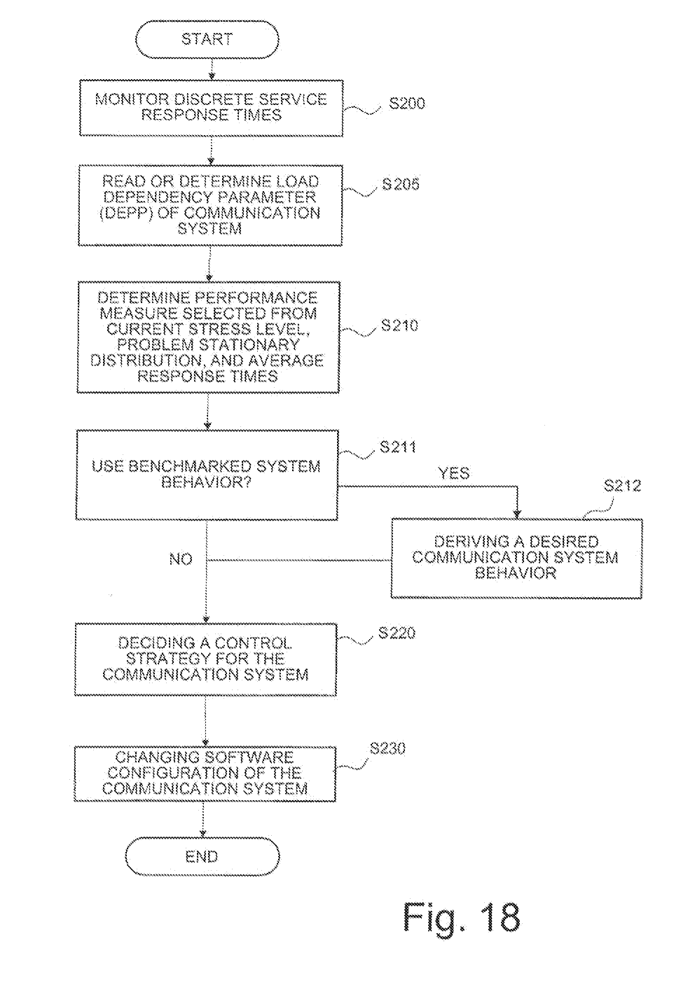

According to FIG. 18, the method of supervisory and decision control for a data processing system may further include step S205, wherein the load dependency parameter depp of the data processing system is a pre-determined parameter of the data processing system and thus stored and in a storage unit and read thereof or is determined based on the above mathematical model.

According to FIG. 18, the method of supervisory and decision control for a data processing system may further step S220 for deciding a control strategy, wherein a software configuration of the data processing system is changed, so as to reduce the value of the load dependency parameter depp of the mathematical model.

Next according to FIG. 18, the method of supervisory and decision control for a data processing system may further include a step S211 to decide whether to use a benchmarked system behaviour and to derive a desired data processing system response behavior for a given data processing system processing load from pre-established benchmark measures in step S212. The decision for the control strategy in step S220 may then further be based on the benchmarked system behaviour and thus to meet the desired data processing system response behaviour.

According to FIG. 18, the method of supervisory and decision control for a data processing system may further include a step S240 to provide a real time view of the at least one performance measures of at least one network element of the data processing system, and a step S250 for providing an early warning about software and/or hardware upgrades in the at least one network element of the data processing system.

### Embodiment 6

### Adaptive Admission Rate Control System

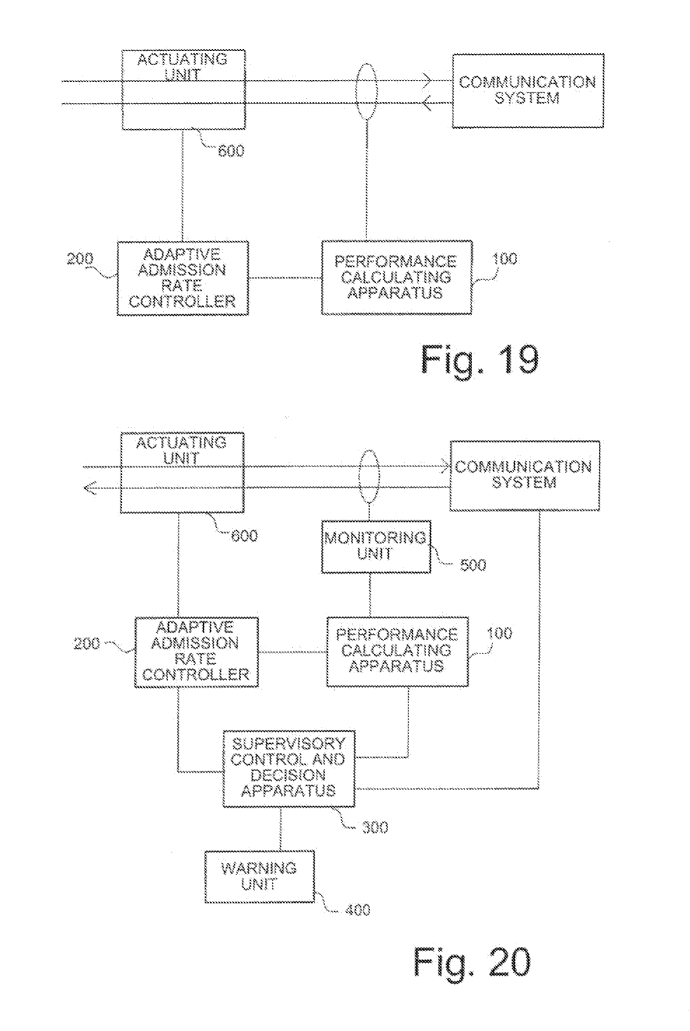

In the following an embodiment of the present invention being related to an adaptive admission rate control system will be described with respect to FIG. 19.

According to FIG. 19 the adaptive admission rate control system comprises the performance calculating apparatus 100 and the adaptive admission rate controller 200, both described above. In particular, the adaptive admission rate controller 200 is connected here to the performance calculating apparatus 100 in order to receive the admission rate control parameter K, which is determined in real time according to the above described inverse secant method shown in FIG. 4.

FIG. 20 shows another example of the adaptive admission rate control system according to the present invention, which further comprises a monitoring unit, a supervisory control and decision unit 300, a warning unit 400, and an actuating unit.

As described above and shown in FIG. 5, the monitoring unit may observe discrete event service requests and/or service response times based on one monitoring variable selected from a group comprising a time stamp, type of service request, identity of service requests, identity of service response, wherein a processing unit in the monitoring unit may calculate latency, throughput and a number of sessions.

Further, the supervisory control and decision unit 300 in the adaptive admission rate control system shown in FIG. 20 may comprise the control strategy deciding unit, the display unit, the data processing system configuration unit, the benchmarking unit, and the control strategy deciding unit described above.

The supervisory control and decision apparatus 300 shown in FIG. 20 takes performance measures from the performance calculation apparatus, does a business rule evaluation and sends an updated control strategy to the control strategy. Decisions are finally sent to the Executor.

According to FIG. 20 the adaptive admission rate control system may further contain a rule engine that based on a number of business rules will provide concrete advices about what actions that should be taken. This could involve everything from limiting the incoming load via reconfiguration of distribution algorithms in load-balancers to updates of the physical server that hosts the monitored process. This will turn the solution into a very intelligent expert system.

The output can either be integrated in an implemented system that automatically acts according to the new control strategy, or it can trigger a human task to improve current configuration of the systems.

The rule engine can also bring in additional facts to evaluate in the business rules. A typical example is to bring in benchmarking data to validate current state in relation to an ideal process behavior before deciding the right control strategy. This can be used to supervise that a process has the expected behavior, but it could also be used to benchmark between different systems, like for example different system versions or systems from different vendors.

The adaptive admission rate control system may further comprise a reporter, which compiles condensed Performance Measures and information from Controller and sends this to Supervisory View via a new and dedicated protocol.

Each Network Element in the network of the data processing system will have its own instance of Reporter, at the same time as there is a single centralized Supervisory View apparatus. To avoid choking the network with Admission control information the Reporter only provides information to the Supervisory View component when the Network element is moving out of the normal operations area.

This means that it is done in a discrete event domain manner. The reporter does not report status while the network element is in a normal operations mode. When the network elements starts moving out of the normal area the Reporter starts sending information to the centralized Supervisory View apparatus about the current utilization and throughput. This could also be the case when the difference between models and reality very quickly is increasing.

Input into the Reporter apparatus is control variables, state variables, innovation variables and model goodness of fit measures. The inputs are delivered in discrete time as verbose information. The reporter condenses the information to discrete event information to reduce signaling towards the apparatus Supervisory View & Control. The transformation between time to event domain is performed by checking the signals for thresholds, obtaining statistics measures such as mean and covariance, trend shifts etc. Since this is of standard transformation they are not described here.

This incoming information to the reporter apparatus can thus be condensed to hold the following information:

### Control Variables:

check for thresholds
large regulation effort points to under-capacity in Network Element
Small regulation effort points to over-capacity in Network Element

### State Variables:

checked for thresholds
warning flags for internal state information in Network Element (only variables that exist in the Network Model are available)

### Innovation Variables:

shows the difference between model and reality
gives a look ahead information
gives fast info of upcoming events of some root cause
combined with state information and regulation effort it can possible point to root cause in some cause domain

### Model Goodness of Fit:

under Network Element in normal operation it tells how well the model emulates the real system given normal measurement noise and model approximation
under Network Element not in normal operation it tells how much it deviates from measurement noise and assumed model
Operators can observe and learn pattern from this measure over time pointing to a known and specific root cause

The adaptive admission rate control system may further contain a supervisory view unit in the supervisory control and decision apparatus 300, which is a centralized component that uses information from all deployed reporter apparatuses to present information about the current network utilization. This provides a very powerful planning tool for operating personal in charge of capacity planning, necessary upgrades, etc.

In particular, the supervisory view unit is constituted of the following components:

Real-time view: This it a GUI that provides a real-time cockpit view of the current load in the network elements. It also shows the current level of Admission control regulation in the network (when applicable).

Historic view: This is a GUI where it is possible to view statistics and do trend analyses based on historic data.

Statistics: This component hosts a database with historical data. It also provides the mean to create statistical data, like summaries over time.

The Supervisory View unit further provides the following external interfaces:

Network Administrators and other personal in charge of capacity planning and necessary upgrades is the main user of the supervisory view unit. They can use the information provided in the tool to plan for new network upgrades, to evaluate capacity of different competing vendors, evaluate how new version of network behaves in relation to old versions and much more. They will also use the information to validate that Admission Control regulations works as it is intended and that the models are accurate enough to provide a valuable result

It is possible to configure the supervisory view unit to send alarms to the Operating and Support Systems (OSS) in critical situation. A typical critical situation is when a network element is operating very close to overload. Another critical situation could be when the difference between models and reality very quickly is increasing.

Each connected Network Element will have a reporter apparatus that sends the necessary information to the supervisory view unit. This is typical done in a discrete time domain manner, which means that it does not to report status while in a normal operations mode. It is only when the network elements starts moving out of the normal area that the Reporter starts sending information to the centralized Supervisory View apparatus.

Barriers between queuing theory and control theory together with a lack of analytical models have prevented in the prior art the design of efficient adaptive control, supervisory control and decision making tools for general purpose load dependent discrete event data processing systems. The combination of queuing theory and control theory, which is condensed in the above mathematical model, leads to the unexpected result to provide performance calculation, adaptive admission control, and supervisory control for the load dependent data processing system by only remotely monitoring discrete service event response times of the data processing system. Thus, no internal information of the data processing system about the load dependent state is necessary. Further, no external analyzing with respect to the type of discrete service event or the behaviour of the discrete service event is required.

### Further Embodiments of the Present Invention

The new apparatuses and methods can be used together with commonly known systems like Controllers and Readers to achieve a number of further embodiments of the present invention.
Admission Control, where the components automatically regulate the incoming traffic to the Load Dependent Discrete Event Process to prevent it from being overloaded when there is a high load.
Supervisory Control and Process Optimization, where components decides a control strategy that should be enforced on the Discrete Event Process as such. This can be anything from opening up more ports to increasing the cache memory or number of disks on the servers.
Supervisory Control and Benchmarking, where the components also bring in benchmarking data before they decide a control strategy. This can be used to supervise that a process has the expected behavior, but it could also be used to benchmark between different systems, like for example different system versions or different system vendors.
Capacity Planning, where the “Performance Measures” are presented in a graphical user interface to provide both real-time and historical views of the network utilization and capacity margins.

Each further embodiment of the present invention is described in more detail in the following.

### Admission Control

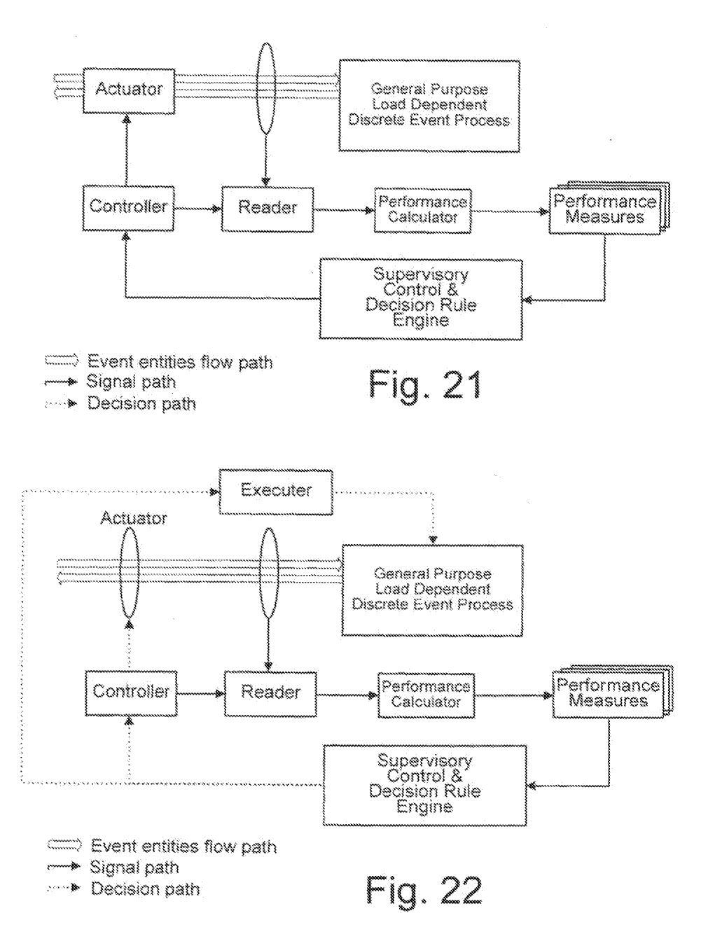

FIG. 21 shows an implementation of an admission control solution, where the admission control components regulates the incoming traffic to the Load Dependent Discrete Event Process to prevent it from being overloaded when there is a high load.

The admission control solution includes the following apparatuses and methods:
Reader: The Reader sniffs on the communication to and from the discrete event process in order to get information about current throughput and latency. It implements the method “Transforms from Discrete Event Domain to Discrete Time Domain” and sends the result to the Performance Calculator.
Performance Calculator: The performance calculator interprets the load situation in the process, and it knows the path how and why it got into this state. It contains an embedded model of the process that is an abstract and simplified representation of the behavior of the physical process. The resulting Performance Measures are sent to the “Supervisory Control & Decision Rule Engine”.
Supervisory Control & Decision Rule Engine: The Supervisory Control and Decision Rule Engine apparatus takes performance measures from the performance calculator, evaluates a set of decision rules and send the resulting control strategy to the Controller.
Controller: The Controller knows how to get out of a certain state in a controlled manner. Future controlling plan is embedded in the controller. It gives directives to take actions to the Actuator component.
Actuator: The Actuator executes controller action commands by adding additional latency to the transaction or by implementing a token bucket solution.

The admission control solution provides the following advantages: Admission Control will be an independent component that observes current state of an ongoing process, and automatically regulates the incoming traffic to prevent overload scenarios. This will make it possible to dimension the networks with a much higher degree of utilization.

Further, each admission control solution is expert on the system where it is deployed, and it can immediately see when the normal behavior from the network element is changing.

Without having to worry about potential overload scenarios it is possible to maximize the output from the systems it is possible to maximize the capacity in each network element. There is no longer a need for extra safety margins in the dimensioning of each customer solution. Fully utilizing the existing hardware investments makes it possible to lower the overall costs.

The admission control solution will also provide more freedom to dimension the systems and decide what hardware to use, since the software always does a best effort on the hardware it gets deployed on. If the hardware is under dimensioned Admission control will handle the potential overload situations in a graceful way. This mechanism also results in less tuning costs for the systems.

The solution will also make it possible for operators to reuse existing hardware for new software released. This will simplify the upgrades.

Admission control solutions can be introduced together with existing products that communicate a lot with external systems. The admission control solution will then make them more robust and prevent them from overloading the surrounding network elements.

### Supervisory Control and Process Optimization

FIG. 22 shows an implementation of a supervisory control and process optimization solution, where the supervisory control and decision rule engine decides a control strategy that should be enforced on the Discrete Event Process, this can be anything from opening up more ports to increasing the cache memory or the number of disks on the involved servers.

The supervisory control and process optimization solution includes the following Apparatuses and Methods:

Reader: The Reader sniffs on the communication to and from the discrete event process in order to get information about current throughput and latency. It implements the method “Transforms from Discrete Event Domain to Discrete Time Domain” and sends the result to the Performance Calculator.

Performance Calculator: The performance calculator interprets the load situation in the process, and it knows the path how and why it got into this state. It contains an embedded model of the process that is an abstract and simplified representation of the behavior of the physical process. The resulting Performance Measures are sent to the “Supervisory Control & Decision Rule Engine”.

Supervisory Control & Decision Rule Engine: The Supervisory Control and Decision Rule Engine apparatus takes performance measures from the performance calculator, evaluates a set of decision rules and results in a control strategy. This control strategy can be applied to the Controller or the Executer via either an automatic integration or manual work.

Controller: In this scenario the Controller might be a human actor that acts based on the control strategy provided by the “Supervisory Control and Decision Rule Engine”. A typical control strategy can be to open up more ports on the server or reconfigure the load-balancers to allow more or less traffic.

Actuator: In this embodiment there is not necessarily a proper Actuator apparatus. It can instead be an implicit Actuator in the form of open ports on the server where the discrete event process is running, or a configuration of a load-balancer that distribute the traffic to several server instances where the discrete event process is running.

Executor: The Executor might be a human actor that acts based on the control strategy provided by the “Supervisory Control and Decision Rule Engine”. A typical control strategy can be to open increase the data caching on the server or increase the number of CPU's and physical disks.

The supervisory control and process optimization solution provides the following advantages: It will give a very early and accurate warning of systems that are getting closer to overload. This gives the operator more lead time to plan for upgrades, and the upgrades will be possible to finish before the end-user is hit by malfunctioning services in overloaded systems.

Without this kind of system the operators can get information about CPU and memory utilization, but what this really means in terms of perceived quality of service is hard to say, since a system can have very low CPU utilization but still be overloaded due to heavy IO communication.

The Performance Calculator reports the perceived capacity in real-time. The mathematical model the solution is based on has the ability to differentiate temporary fluctuations from the general trends. This information will provide unique capabilities to feel the current state of the systems and give very early information of tendencies of under-capacity.

Since the solution uses a rule engine it will not only provide a measurement of current load and a prediction of the future. Based on predefined business rules it can also provide concrete advices about what actions that should be taken. This could involve everything from limiting the incoming load via reconfiguration of distribution algorithms in load-balancers to updates of the physical server that hosts the monitored process. This will turn the solution into a very intelligent expert system.

The operators have been very focused on growth, but the market is now stabilizing and getting much more mature. As a result the operators change their focus from growth to minimizing their operating costs (OPEX). An important way to become cost efficient is to have a good planning of the capacity in the network.

An expert system based on Admission control will leverage on the unique Admission Control technology and deliver a more accurate and up-to-date information about the state of the network elements than similar tools today. With more and more operators changing mindset from growth to cost efficiency the market potential will be huge.

The supervisory control and process optimization solution provides the following advantages. The Supervisory Control and Process Optimization solution will give a very early and accurate warning of systems that are getting closer to overload. This gives the operator more lead time to plan for upgrades, and the upgrades will be possible to finish before the end-user is hit by malfunctioning services in overloaded systems.

Without this kind of system the operators can get information about CPU and memory utilization, but what this really means in terms of perceived quality of service is hard to say, since a system can have very low CPU utilization but still be overloaded due to heavy IO communication.

The Performance Calculator reports the perceived capacity in real-time. The mathematical model the solution is based on has the ability to differentiate temporary fluctuations from the general trends. This information will provide unique capabilities to feel the current state of the systems and give very early information of tendencies of under-capacity.

Since the solution also a rule engine it will not only provide a measurement of current load and a prediction of the future. Based on predefined business rules it can also provide concrete advices about what actions that should be taken. This could involve everything from limiting the incoming load via reconfiguration of distribution algorithms in load-balancers to updates of the physical server that hosts the monitored process. This will turn the solution into a very intelligent expert system.

The operators have been very focused on growth, but the market is now stabilizing and getting much more mature. As a result the operators change their focus from growth to minimizing their operating costs (OPEX). An important way to become cost efficient is to have a good planning of the capacity in the network.

An expert system based on Admission control will leverage on the unique Admission Control technology and deliver a more accurate and up-to-date information about the state of the network elements than similar tools today. With more and more operators changing mindset from growth to cost efficiency the market potential will be huge.

### Supervisory Control and Benchmarking

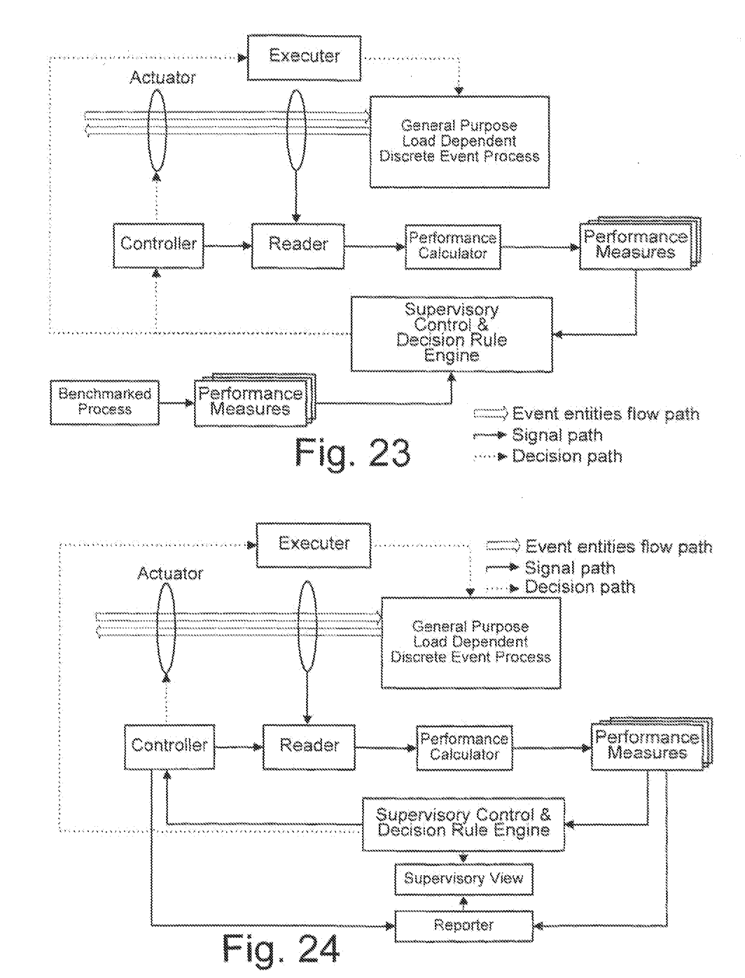

FIG. 23 shows an implementation of a supervisory control and benchmarking solution, where the supervisory control and decision rule engine brings in benchmarking data before it decides a control strategy.

The supervisory control and benchmarking solution includes the following Apparatuses and Methods:
Reader: The Reader sniffs on the communication to and from the discrete event process in order to get information about current throughput and latency. It implements the method “Transforms from Discrete Event Domain to Discrete Time Domain” and sends the result to the Performance Calculator.
Performance Calculator: The performance calculator interprets the load situation in the process, and it knows the path how and why it got into this state. It contains an embedded model of the process that is an abstract and simplified representation of the behavior of the physical process. The resulting Performance Measures are sent to the “Supervisory Control & Decision Rule Engine”.
Supervisory Control & Decision Rule Engine: The Supervisory Control and Decision Rule Engine apparatus takes performance measures from the performance calculator and benchmarking figures from the benchmarked processes. Based on this information it evaluates a set of decision rules which will result in a control strategy. This control strategy can be applied to the Controller or the Executer via either an automatic integration or manual work.
Benchmarked process: The benchmarked processes will be used as additional input data by the Supervisory Control Decision Rule Engine to decide the best control strategy. The benchmarked process can be an ideal case the regulation should try to reach. To large deviations will trigger the rule engine to issue an updated control strategy. The benchmarked process can also be used to benchmark between different system versions and different system vendors.
Controller: In this scenario the Controller might be a human actor that acts based on the control strategy provided by the “Supervisory Control and Decision Rule Engine”. A typical control strategy can be to open up more ports on the server or reconfigure the load-balancers to allow more or less traffic.
Actuator: In this embodiment there is not necessarily a proper Actuator apparatus. It can instead be an implicit Actuator in the form of open ports on the server where the discrete event process is running, or a configuration of a load-balancer that distribute the traffic to several server instances where the discrete event process is running.
Executor: The Executor might be a human actor that acts based on the control strategy provided by the “Supervisory Control and Decision Rule Engine”. A typical control strategy can be to open increase the data caching on the server or increase the number of CPU's and physical disks. If the benchmarked process provides information about an expected system behavior, and the “Supervisory Control & Decision Rule Engine” finds a large deviation to this in the supervised process it can even trigger the Executor to do a more detailed trouble-shooting and root-cause analysis.

The supervisory control and benchmarking solution provides the following advantages: Using the proposed innovations together with benchmarking data will provide a very efficient tool to validate that the implemented systems are behaving in an optimal way.

The benchmarked process can be an ideal case the regulation should try to reach. To large deviations will trigger the “Supervisory Control & Decision Rule Engine” to issue an updated control strategy. The benchmarked process can also be used to benchmark between different system versions and different system vendors.

In a real life solution there is seldom just one server that runs a process. There will be a number of servers that share the load. To achieve a proper availability figures there will be a number of redundant servers in place. Requirements on geographical redundancy might force the different servers to be spread on different locations.

On top of this there are life-cycle aspects, like different software and hardware version, where there at least during migration might be necessary to support several combination at the same time. Finally there might be several vendors providing systems that do the same task.

Considering this magnitude of servers, versions and locations in a real life implementation, it can easily become a mess to secure that the best capacity is provided by all the systems. Managing one server that executes a process is easy, but this more realistic example requires something else.

With “Supervisory Control and Benchmarking” it is possible to automatically benchmark all the servers to an ideal process behavior. This is the process behavior all the systems should try to reach. To large deviations will trigger an updated control strategy for the specific system. This will turn the solution into a very intelligent expert system and make the complex much easier to manage and optimize.

### Capacity Planning

FIG. 24 shows an implementation of a capacity planning solution, where the “Performance Measures” are presented in a graphical user interface to provide both real-time and historical views of the network utilization and capacity margins.

The present invention includes the following Apparatuses and Methods:
Reader: The Reader sniffs on the communication to and from the discrete event process in order to get information about current throughput and latency. It implements the method “Transforms from Discrete Event Domain to Discrete Time Domain” and sends the result to the Performance Calculator.
Performance Calculator: The performance calculator interprets the load situation in the process, and it knows the path how and why it got into this state. It contains an embedded model of the process that is an abstract and simplified representation of the behavior of the physical process. The resulting Performance Measures are sent to the “Supervisory Control & Decision Rule Engine”.
Supervisory Control & Decision Rule Engine: The Supervisory Control and Decision Rule Engine apparatus takes performance measures from the performance calculator, evaluates a set of decision rules and results in a control strategy. This control strategy can be applied to the Controller or the Executer via either an automatic integration or manual work. It can also be presented in the Supervisory View.
Controller: The Controller knows how to get out of a certain state in a controlled manner. Future controlling plan is embedded in the controller. It gives directives to take actions to the Actuator component.
Actuator: The Actuator executes controller action commands by adding additional latency to the transaction or by implementing a token bucket solution.
Reporter: The Reporter gathers Performance Measures and information from the Controller to provide a status update to the Supervisory View component when the Network element is moving out of the normal operations area.
Supervisory View: The Supervisory View is a centralized component that uses information from all deployed Reporters to present information about the current network utilization. This provides a very powerful planning tool. The tool provides both real-time information and statistics and trend analyses based on historic data. During high load situations it can also fire of alarms towards OSS. Supervisory View can also show the output from the Supervisory Control & Decision Rule Engine.

The capacity planning solution will provide the following advantages. The planning tool based on Admission control will give a very early warning of systems that are getting closer to overload. This gives the operator more lead time to plan for upgrades, and the upgrades will be possible to finish before the end-user is hit by malfunctioning services in overloaded systems.

Each Admission control component is expert on the system where it is deployed, and it can immediately see when the normal behavior from the network element is changing. Without this kind of system the operators can get information about CPU and memory utilization, but what this really means in terms of perceived quality of service is hard to say, since a system can have very low CPU utilization but still be overloaded due to heavy IC communication.

The Admission control reports the perceived capacity in real-time. The mathematical model in the component also has the ability to differentiate temporary fluctuations from the general trends. This information will provide the base for a planning tool with unique capabilities to feel the current state of the systems and give very early information of tendencies of under-capacity.

The operators have been very focused on growth, but the market is now stabilizing and getting much more mature. As a result the operators change their focus from growth to minimizing their operating costs (OPEX). An important way to become cost efficient is to have a good planning of the capacity in the network.

Admission control is a brand new technology that evaluates the load and capacity of the network elements. A planning tool based on this information will leverage on the unique Admission Control technology and deliver a more accurate and up-to-date information about the state of the network elements than similar tools today. The Capacity Planning Tool will help the operators to better utilize their networks. This is very important since the operators gets much more cost-aware and do not want to spend money on extra capacity in the network that never gets used. With the planning tool it will be possible to improve the margins by reducing unnecessary extra capacity in the network and by that reduce the operators CAPEX and OPEX.

The solutions of the present invention may be deployed in several different ways:
Distributed Observe and Control Solution: Each Network Element contains an instance of the Admission Control components Reader, Performance Calculator, Controller, Actuator and Reporter. The Admission Control components regulate the incoming management traffic to prevent the network element from being overloaded when there is a high external load. It also reports information about current network load to the centralized Supervisory View.
Distributed Observe Solution: Each Network Element contains an instance of the Admission Control components Reader, Performance Calculator and Reporter. Those components report information about current network load to the centralized Supervisory View component.
Centralized Observe Solution: Each Network Element contains an instance of the Reader Admission Control component. This component report information about current throughput, latency and used sessions to the centralized Performance Calculator, Reporter and Supervisory View components. In this case there will still be a separate instance of Performance Calculator and Reporter for every network element that is observed.

The above embodiments of the present invention may be used in any kind of data processing system, for example in a Media Activation System where service activation requests are processed or in a Charging System where requests or billing records are processed.

1-31. (canceled)

32. A performance calculation apparatus for calculating at least one performance measure of a data processing system, comprising:
an interface unit adapted to receive monitored discrete service response times measured for the data processing system;
a data processing system modelling unit adapted to model the data processing system using a mathematical model based on a birth-death chain with a birth parameter (λₖ) and a load-dependent death parameter (μₖ), wherein adding a discrete service event to the data processing system is described by the same birth parameter and wherein deleting a discrete service event from the data processing system is described by the load dependent death parameter
$${μ}_{k} = \{ \begin{matrix}\frac{k \cdot μ}{{depp}^{k - 1}} & if 0 \leq k < m \\ \frac{m \cdot μ}{{depp}^{m - 1}} & if k \geq m\end{matrix}$$
wherein depp is a load parameter of the data processing system, k is the number of discrete service events, and m is the number of servers in the data processing system,
whereby the data processing system modelling unit is further adapted to use the mathematical model to establish a relationship between monitored discrete service event response times and arrival rates of discrete service events of the data processing system; and
a performance measure calculation unit adapted to calculate at least one data processing system performance measure using the mathematical model and the monitored discrete service response times.

33. The performance calculation apparatus according to claim 32, wherein the mathematical model is represented as a model curve describing monitored discrete service event response times as a function of incoming service request rates; and
the performance measure calculation unit is adapted to derive an inverse of the curve gradient of the model curve for subsequent use in an adaptive admission rate control process of the data processing system.

34. The performance calculation apparatus according to claim 33, wherein the performance measure calculation unit is adapted to calculate the at least one data processing system performance measure as performance measure selected from a group comprising a current stress level, a stationary probability distribution for a number of discrete service events in the data processing system, and average response times for discrete service events in the data processing system.

35. An adaptive admission rate controller for adaptive admission control of discrete service events submitted to a data processing system, comprising:
a controller unit adapted to execute an adaptive admission rate control for discrete service events to achieve a desired response time on the basis of monitored discrete service event response times and an admission rate control parameter (K) calculated from a mathematical model based on a birth-death chain with a birth parameter (λₖ) and a load-dependent death parameter (μₖ), wherein adding a discrete service event to the data processing system is described by the same birth parameter and wherein deleting a discrete service event from the data processing system is described by the load dependent death parameter
$${μ}_{k} = \{ \begin{matrix}\frac{k \cdot μ}{{depp}^{k - 1}} & if 0 \leq k < m \\ \frac{m \cdot μ}{{depp}^{m - 1}} & if k \geq m\end{matrix}$$
wherein depp is a load parameter of the data processing system, k is the number of discrete service events, and m is the number of servers in the data processing system,
whereby the mathematical model establishes a relationship between discrete service event response times and arrival rates of discrete service events.

36. The adaptive admission rate controller according to claim 35, further comprising a receiving unit adapted to receive the admission rate control parameter (K) from an external performance calculation apparatus that comprises:
an interface unit adapted to receive monitored discrete service response times measured for the data processing system;
a data processing system modelling unit adapted to model the data processing system using the mathematical model, whereby the data processing system modelling unit is further adapted to use the mathematical model to establish a relationship between monitored discrete service event response times and arrival rates of discrete service events of the data processing system; and
a performance measure calculation unit adapted to calculate at least one data processing system performance measure using the mathematical model and the monitored discrete service response times.

37. The adaptive admission rate controller according to claim 36, further comprising:
a control criteria selection unit adapted to select a control criteria underlying performance maximization of the data processing system.

38. The adaptive admission rate controller according to claim 35, wherein
the controller unit is a PI controller being operated according to the calculated admission rate control parameter (K).

39. The adaptive admission rate controller according to claim 38, wherein the PI-controller comprises a non-linear load adaptive unit adapted to block wind up of the PI control process.

40. The adaptive admission rate controller according to the claim 35, wherein the admission of discrete service events to the data processing system is implemented through an actuator, and the controller unit is adapted to control adaptive admission rate control for discrete service events by modifying a gate opening or gate closing in the actuator or by imposing latency in flow in the actuator.

41. The adaptive admission rate controller according to claim 38, wherein the admission rate control parameter (K) is calculated in real time.

42. A supervisory control and decision apparatus for a data processing system, comprising:
a monitoring unit adapted to monitor discrete service response times for at least one predetermined period of time;
a performance measure determining unit adapted to determine at least one load dependent performance measure of the data processing system on the basis of the monitored discrete service response times and a mathematical model based on a birth-death chain with a birth parameter (λₖ) and a load-dependent death parameter (μₖ), wherein adding a discrete service event to the data processing system is described by the same birth parameter and wherein deleting a discrete service event from the data processing system is described by the load dependent death parameter
$${μ}_{k} = \{ \begin{matrix}\frac{k \cdot μ}{{depp}^{k - 1}} & if 0 \leq k < m \\ \frac{m \cdot μ}{{depp}^{m - 1}} & if k \geq m\end{matrix}$$
wherein depp is a load parameter of the data processing system, k is the number of discrete service events, and m is the number of servers in the data processing system,
whereby the mathematical model establishes a relationship between discrete service event response times and arrival rates of discrete service events; and
a control strategy deciding unit adapted to decide on a control strategy according to the at least one load dependent performance measure on the basis of a degree of utilization and/or a set of pre-established regulation rules for the data processing system.

43. The supervisory control and decision apparatus according to claim 42, further comprising:
a display unit adapted to display a real time view of a current load dependent state of at least one network element in the data processing system on the basis of the mathematical model.

44. The supervisory control and decision apparatus according to claim 42, wherein the mathematical model relies on the load dependency parameter (depp) describing an increase of discrete service event response times according to a current admission rate to the data processing system, and further comprising:
a data processing system configuration unit adapted to change a software configuration of the data processing system so as to reduce a value of the load dependency parameter (depp) of the mathematical model.

45. The supervisory control and decision apparatus according to claim 42, further comprising:
a benchmarking unit adapted to derive a desired data processing system response behaviour for a given data processing system processing load from pre-established benchmarked performance measures; wherein
the control strategy deciding unit is adapted to decide on the control strategy deciding to meet the desired data processing system response behaviour.

46. A method of adaptive admission rate control for a discrete service event in a data processing system, comprising the steps of:
monitoring discrete service event response times for at least one predetermined period of time;
executing an adaptive admission rate control for discrete service events to achieve a desired response time on the basis of the monitored discrete service event response times and a admission rate control parameter (K) calculated from a mathematical model based on a birth-death chain with a birth parameter (λₖ) and a load-dependent death parameter (μₖ), wherein adding a discrete service event to the data processing system is described by the same birth parameter and wherein deleting a discrete service event from the data processing system is described by the load dependent death parameter
$${μ}_{k} = \{ \begin{matrix}\frac{k \cdot μ}{{depp}^{k - 1}} & if 0 \leq k < m \\ \frac{m \cdot μ}{{depp}^{m - 1}} & if k \geq m\end{matrix}$$
wherein depp is a load parameter of the data processing system, k is the number of discrete service events, and m is the number of servers in the data processing system, and
whereby the mathematical model establishes a relationship between discrete service event response times and arrival rates of discrete service events.

47. The method of adaptive admission rate control according to claim 46, further comprising the steps of:
determining from the mathematical model at least one performance measure of the data processing system.

48. The method of adaptive admission rate control according to claim 47, wherein the performance measures are selected from a group comprising a current stress level, a stationary probability distribution for a number of discrete service events in the data processing system, and average response times for discrete service events in the data processing system.

49. The method of adaptive admission rate control according to claim 48, wherein the mathematical model is represented as a model curve describing discrete service event response times as a function of incoming service request rates, and wherein the method further comprises the step of:
deriving the control parameter (K) from an inverse of the curve gradient of the model curve.

50. The method of adaptive admission rate control according to claim 48, further comprising the step of:
modifying the control parameter (K) according to system responsiveness requirements for adaptive admission rate control.

51. The method of adaptive admission rate control according to claim 46, wherein the mathematical model relies on the load dependency parameter (depp) describing an increase of discrete service event response times according to a current admission rate to the data processing system, and wherein
the load dependency parameter (depp) is a predetermined system parameter of the data processing system and is derivable prior to start of data processing system operation.

52. The method of adaptive admission rate control according to claim 46, further comprising the step of deciding on a control strategy according to the at least one load dependent performance measure on the basis of a degree of utilization and/or a set of pre-established regulation rules for the data processing system.

53. A method of supervisory and decision control of a data processing system, comprising the steps of:
monitoring discrete service response times for at least one predetermined period of time in the data processing system;
determining at least one load dependent performance measure of the data processing system on the basis of the monitored discrete service response times and a mathematical model based on a birth-death chain with a birth parameter (λₖ) and a load-dependent death parameter (μₖ), wherein adding a discrete service event to the data processing system is described by the same birth parameter and wherein deleting a discrete service event from the data processing system is described by the load dependent death parameter
$${μ}_{k} = \{ \begin{matrix}\frac{k \cdot μ}{{depp}^{k - 1}} & if 0 \leq k < m \\ \frac{m \cdot μ}{{depp}^{m - 1}} & if k \geq m\end{matrix}$$
wherein depp is a load parameter of the data processing system, k is the number of discrete service events, and m is the number of servers in the data processing system,
whereby the mathematical model establishes a relationship between discrete service event response times and arrival rates of discrete service events; and
deciding on a control strategy according to the at least one load dependent performance measure on the basis of a degree of utilization and/or a set of pre-established regulation rules for the data processing system.

54. The method of supervisory and decision control according to claim 53, wherein the at least one load dependent performance measure is selected from a group comprising a current stress level, a stationary probability distribution, and average response times.

55. The method of supervisory and decision control according to claim 54, wherein the mathematical model relies on the load dependency parameter (depp) describing an increase of discrete service event response times according to a current admission rate to the data processing system, and wherein the method further comprises the step of:
changing a software configuration of the data processing system so as to reduce a value of the load dependency parameter (depp) of the mathematical model.

56. The method of supervisory and decision control according to claim 53, further comprising the steps:
deriving a desired data processing system response behaviour for a given data processing system processing load from pre-established benchmarked performance measures; and
deciding on the control strategy to meet the desired data processing system response behaviour.

57. The method of supervisory and decision control according to claim 53, further comprising the steps of:
providing a real-time view of the at least one performance measure of at least one network element in the data processing system; and
providing an early warning about software and/or hardware upgrades in the at least one network element of the data processing system.

58. An adaptive admission rate control system for achieving adaptive admission rate control of discrete service events to a data processing system, comprising:
a performance calculating apparatus comprising:
an interface unit adapted to receive monitored discrete service response times measured for the data processing system;
a data processing system modelling unit adapted to model the data processing system using a mathematical model based on a birth-death chain with a birth parameter (λₖ) and a load-dependent death parameter (μₖ), wherein adding a discrete service event to the data processing system is described by the same birth parameter and wherein deleting a discrete service event from the data processing system is described by the load dependent death parameter
$${μ}_{k} = \{ \begin{matrix}\frac{k \cdot μ}{{depp}^{k - 1}} & if 0 \leq k < m \\ \frac{m \cdot μ}{{depp}^{m - 1}} & if k \geq m\end{matrix}$$
wherein depp is a load parameter of the data processing system, k is the number of discrete service events, and m is the number of servers in the data processing system, and
whereby the data processing system modelling unit is further adapted to use the mathematical model to establish a relationship between monitored discrete service event response times and arrival rates of discrete service events of the data processing system; and
a performance measure calculation unit adapted to calculate at least one data processing system performance measure using the mathematical model and the monitored discrete service response times; and
further comprising an adaptive admission rate controller that is connected to the performance calculating apparatus for receipt of the admission rate control parameter (K) and adapted to provide adaptive admission control of discrete service events submitted to the data processing system, wherein the adaptive admission rate controller comprises:
a controller unit adapted to execute an adaptive admission rate control for discrete service events to achieve a desired response time on the basis of monitored discrete service event response times and the admission rate control parameter (K).

59. The adaptive admission rate control system according to claim 58, further comprising:
a monitoring unit adapted to monitor discrete service response times for at least one predetermined period of time; and
a supervisory control and decision apparatus according, wherein the supervisory control and decision apparatus comprises:
a control strategy deciding unit adapted to decide on a control strategy according to the at least one load dependent performance measure on the basis of a degree of utilization and/or a set of pre-established regulation rules for the data processing system;
a display unit adapted to display a real time view of a current load dependent state of at least one network element in the data processing system on the basis of the mathematical model;
a data processing system configuration unit adapted to change a software configuration of the data processing system so as to reduce a value of the load dependency parameter (depp) of the mathematical model; and
a benchmarking unit adapted to derive a desired data processing system response behaviour for a given data processing system processing load from pre-established benchmarked performance measures; wherein the control strategy deciding unit is adapted to decide on the control strategy deciding to meet the desired data processing system response behaviour.

60. The adaptive admission rate control system according to claim 58, further comprising:
an actuating unit adapted to execute of an adaptive admission of discrete service events to the data processing system.

61. The adaptive admission rate control system according to claim 58, further comprising:
a monitoring unit adapted to monitor service requests and/or service response times based on one monitoring variable selected from a group comprising time stamp, type of service request, identity of service request, identity of service responses; and wherein the monitoring unit further comprises:
a processing unit adapted to calculate latency, throughput, and number of sessions.

62. Adaptive admission rate control system according to claim 58, further comprising:
an execution unit adapted to implement a control strategy decided on by the control strategy deciding unit of the supervisory control and decision apparatus; and
a warning unit adapted to generate an early warning indicating that the data processing system is operating close to an data processing system overload condition.
